(19) United States
(12) Patent Application Publication
(10) Pub. No.: US 2013/0223422 A1
(43) Pub. Date: Aug. 29, 2013

(54) SYSTEMS AND METHODS FOR OPTIMIZING WIRELESS TRANSMISSION DATA RATES

(71) Applicants: Santosh Paul Abraham, San Diego, CA (US); Simone Merlin, San Diego, CA (US); Hemanth Sampath, San Diego, CA (US); Zhi Quan, San Diego, CA (US); Rahul Dangui, San Diego, CA (US)

(72) Inventors: Santosh Paul Abraham, San Diego, CA (US); Simone Merlin, San Diego, CA (US); Hemanth Sampath, San Diego, CA (US); Zhi Quan, San Diego, CA (US); Rahul Dangui, San Diego, CA (US)

(73) Assignee: QUALCOMM INcorporated, San Diego, CA (US)

(21) Appl. No.: 13/595,475

(22) Filed: Aug. 27, 2012

Related U.S. Application Data
(60) Provisional application No. 61/530,745, filed on Sep. 2, 2011.

(51) Int. Cl. H04W 24/02

(52) U.S. Cl. CPC H04W 24/02
USPC 370/338

(57) ABSTRACT

One aspect of the disclosure provides a method for wireless communication. The method includes sending a modulation and coding scheme request to an access point. The modulation and coding scheme request is sent using a first physical layer preamble frame. The modulation and coding scheme request includes an identifier associated with the access point. The method further includes receiving at a station a modulation and coding scheme feedback response from the access point in response to sending the modulation and coding scheme request. The modulation and coding scheme feedback response is received as a second physical layer preamble frame. In addition, the method includes determining a modulation and coding scheme based on the modulation and coding scheme feedback response. Moreover, the method includes transmitting data to the access point using the identified modulation and coding scheme.

The present application claims priority to provisional U.S. Application Ser. No. 61/530,745, entitled “SYSTEMS AND METHODS FOR OPTIMIZING WIRELESS TRANSMISSION DATA RATES,” filed Sep. 2, 2011, assigned to the assignee hereof and incorporated herein by reference in its entirety.

### BACKGROUND

1. Field

The present application relates generally to wireless communications, and more specifically to systems, methods, and devices for optimizing wireless transmission data rates. Certain aspects herein relate to determining the fastest available data rate for communication between two wireless nodes.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may transmit/receive information between each other. The information may comprise packets, which in some aspects may be referred to as data units. The packets may include overhead information (e.g., header information, packet properties, etc.) that helps in routing the packet through the network, identifying the data in the packet, processing the packet, etc., as well as data, for example user data, multimedia content, etc. as might be carried in a payload of the packet.

The selection of a modulation and coding scheme is associated with the data rate for communicating between devices. Often, devices are unaware of the optimal modulation and coding scheme because, for example, the devices have not communicated recently and therefore are unaware of the state of devices in a wireless network and the state of the medium. Thus, devices will either use a modulation and coding scheme associated with a low data rate or must expend significant resources using convergence algorithms to eventually determine the optimal modulation and coding scheme. For devices communicating a small number of packets, convergence algorithms will often not have enough time to determine the optimal modulation and coding scheme before transmission of the packets completes.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include decreasing the overhead in transmitting payloads in data packets.

One aspect of the disclosure provides a method for wireless communication. The method includes sending a modulation and coding scheme request to an access point. The modulation and coding scheme request is sent using a first physical layer preamble frame. The method further includes receiving at a station a modulation and coding scheme feedback response from the access point in response to sending the modulation and coding scheme request. The modulation and coding scheme feedback response is received as a second physical layer preamble frame. In addition, the method includes determining a modulation and coding scheme based on the modulation and coding scheme feedback response. Moreover, the method includes transmitting data to the access point using the identified modulation and coding scheme.

In some embodiments, the method includes identifying the modulation and coding scheme based on a modulation and coding scheme field associated with the second physical layer preamble frame. Further, the method may include identifying the modulation and coding scheme based on the modulation and coding scheme field including a bit pattern not associated with a valid modulation and coding scheme.

For some implementations, the modulation and coding scheme feedback response specifies the modulation and coding scheme associated with the fastest data rate that the station can use to ensure correct decoding of data transmitted to the access point. In some instances, the modulation and coding scheme feedback response specifies the modulation and coding scheme associated with the fastest data rate that the station can use to ensure correct decoding of data transmitted to the access point at a specific time.

In certain embodiments, the method can include identifying to the access point a set of modulation and coding schemes supported by the station. In some embodiments, the modulation and coding scheme is associated with the set of modulation and coding schemes. Further, the modulation and coding scheme feedback response can specify the modulation and coding scheme associated with the fastest data rate from the set of modulation and coding schemes that the station can use to ensure correct decoding of data transmitted to the access point.

In some variants, the modulation and coding scheme feedback response may specify a number of available streams. Further, the method may include sending the modulation and coding scheme request using a default modulation and coding scheme. In addition, the modulation and coding scheme feedback response may be transmitted a short interframe space after the modulation and coding scheme feedback request is transmitted. In some embodiments, the method includes receiving an acknowledgement packet in response to transmitting the data.

In certain embodiments, a length field associated with the modulation and coding scheme request is set to zero. Further, a length field associated with the modulation and coding scheme feedback response may be set to zero. In some cases, a length field associated with the modulation and coding scheme feedback response may be set to a value less than the smallest valid 802.11 frame size associated with at least one of the following: a control frame, a data frame, and a management frame. In some implementations, the modulation and coding scheme request includes an identifier associated with the access point. This identifier can include at least one of the following: a hash of a SSID, a hash of a BSSID, and a MAC address.

Another aspect of the disclosure provides a method for wireless communication. The method includes receiving at an access point a modulation and coding scheme request from a station, wherein the modulation and coding scheme request is received as a first physical layer preamble frame. Further, the method includes sending to the station a modulation and coding scheme feedback response in response to receiving the modulation and coding scheme request. The modulation and coding scheme field associated with the modulation and coding scheme feedback response can specify a modulation and coding scheme. Further, the modulation and coding scheme feedback response maybe sent using a second physical layer preamble frame. The method may further include receiving data from the station using the modulation and coding scheme.

Yet another aspect of the disclosure provides a wireless communication apparatus. The wireless communication apparatus includes a transmitter configured to transmit a modulation and coding scheme request to an access point. The modulation and coding scheme request may be sent using a first physical layer preamble frame. Further, the wireless communication apparatus includes a receiver configured to receive a modulation and coding scheme feedback response from the access point in response to transmission of the modulation and coding scheme request. The modulation and coding scheme feedback response may be received as a second physical layer preamble frame. Moreover, the wireless communication apparatus includes a processor configured to determine a modulation and coding scheme based on the modulation and coding scheme feedback response. Further, the transmitter may be further configured to transmit data to the access point using the identified modulation and coding scheme.

Another embodiment of the disclosure provides for an access point for wireless communication. The access point includes at least one antenna. Further, the access point includes a receiver configured to receive via the at least one antenna a modulation and coding scheme request from a station. The modulation and coding scheme request may be received as a first physical layer preamble frame. The access point also includes a transmitter configured to send via the at least one antenna to the station a modulation and coding scheme feedback response in response to receipt of the modulation and coding scheme request. A modulation and coding scheme field associated with the modulation and coding scheme feedback response specifies a modulation and coding scheme. Further, the modulation and coding scheme feedback response may be sent using a second physical layer preamble frame. In addition, the receive may be further configured to receive data from the station using the modulation and coding scheme.

Yet another aspect of the disclosure provides for an apparatus for wireless communication. The apparatus includes means for sending a modulation and coding scheme request to an access point. The modulation and coding scheme request may be sent using a first physical layer preamble frame. Further, the apparatus includes means for receiving a modulation and coding scheme feedback response from the access point. The modulation and coding scheme feedback response may be received as a second physical layer preamble frame. In addition, the apparatus includes means for determining a modulation and coding scheme based on the modulation and coding scheme feedback response. Moreover, the apparatus includes means for transmitting data to the access point using the identified modulation and coding scheme.

Another embodiment of the disclosure provides for an access point for wireless communication. The access point includes means for receiving a modulation and coding scheme request from a station. The modulation and coding scheme request may be received as a first physical layer preamble frame. Further, the access point includes means for sending to the station a modulation and coding scheme feedback response. A modulation and coding scheme field associated with the modulation and coding scheme feedback response specifies a modulation and coding scheme. The modulation and coding scheme feedback response may be sent using a second physical layer preamble frame. In addition, the access point includes means for receiving data from the station using the modulation and coding scheme.

Yet another aspect of the disclosure provides for a non-transitory physical computer storage comprising computer executable instructions configured to implement a method for wireless communication. The method includes sending a modulation and coding scheme request to an access point. The modulation and coding scheme request is sent using a first physical layer preamble frame. The method further includes receiving at a station a modulation and coding scheme feedback response from the access point in response to sending the modulation and coding scheme request. The modulation and coding scheme feedback response is received as a second physical layer preamble frame. In addition, the method includes determining a modulation and coding scheme based on the modulation and coding scheme feedback response. Moreover, the method includes transmitting data to the access point using the identified modulation and coding scheme.

Another embodiment of the disclosure provides for a non-transitory physical computer storage comprising computer executable instructions configured to implement a method for wireless communication. The method includes The method includes receiving at an access point a modulation and coding scheme request from a station, wherein the modulation and coding scheme request is received as a first physical layer preamble frame. Further, the method includes sending to the station a modulation and coding scheme feedback response in response to receiving the modulation and coding scheme request. The modulation and coding scheme field associated with the modulation and coding scheme feedback response can specify a modulation and coding scheme. Further, the modulation and coding scheme feedback response maybe sent using a second physical layer preamble frame. The method may further include receiving data from the station using the modulation and coding scheme.

### BRIEF DESCRIPTION OF THE DRAWINGS

FIG. 1 illustrates an example of a wireless communication system in which aspects of the present disclosure may be employed.

FIG. 2 illustrates an example of a wireless device that may be employed within the wireless communication system of FIG. 1.

FIG. 3 illustrates an example of components that may be included within the wireless device of FIG. 2 to transmit wireless communications.

FIG. 4 illustrates an example of components that may be included within the wireless device of FIG. 2 to transmit wireless communications.

FIG. 5 illustrates an example of a physical layer data unit.

FIG. 6 presents a flowchart for one embodiment of a data transmission process.

FIG. 7 presents a flowchart for one embodiment of a data reception process.

FIG. 8 illustrates an example of a packet flow in accordance with an embodiment of the present disclosure.

FIG. 9 illustrates another example of a wireless device that may be employed within the wireless communication system of FIG. 1.

FIG. 10 illustrates an example of an access point that may be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11 ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAB”). In general, an AP serves as a hub or base station for the WLAN and a STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations, an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“FDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

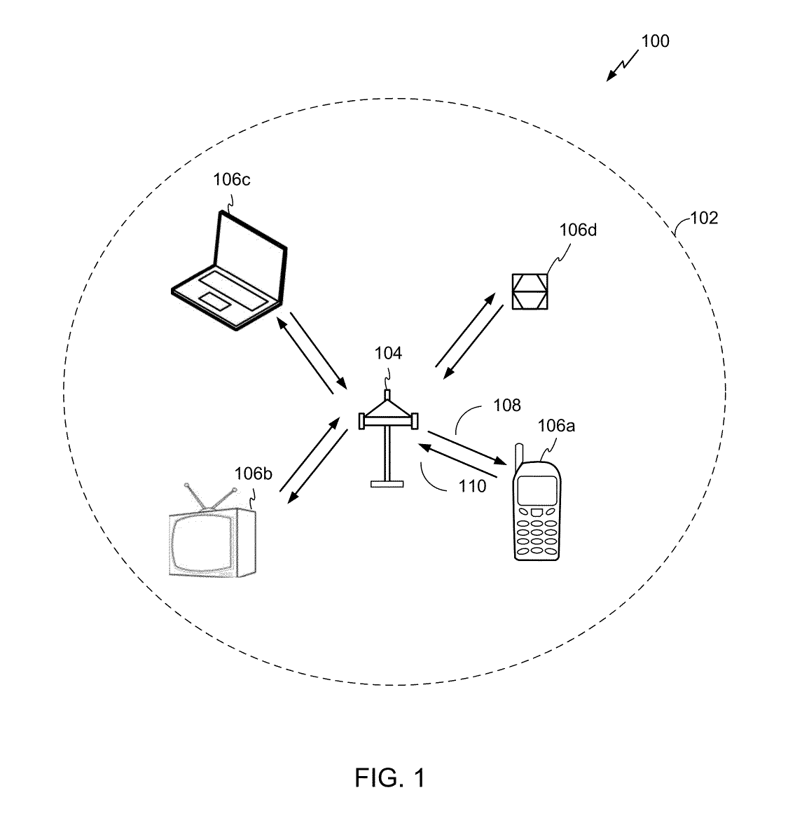

FIG. 1 illustrates an example of a wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106.

The STAs 106 are not limited in type and may include a variety of different STAs. For example, as illustrated in FIG. 1, STAs 106 can include a cellular phone 106a, a television 106b, a laptop 106c, and a sensor 106d (e.g. a weather sensor or other sensor capable of communicating using a wireless protocol), to name a few.

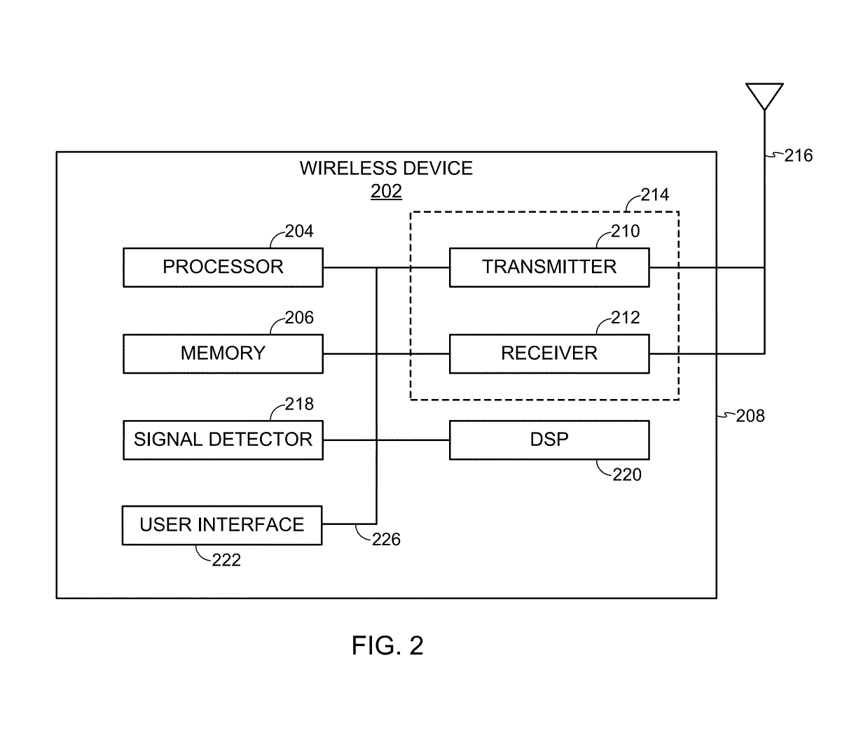

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a transmitter 210 and a receiver 212 to allow transmission and reception of data between the wireless device 202 and a remote location. Further, the transmitters 210 and the receiver 212 may be configured to allow transmission and reception of setup and/or configuration packets or frames between the wireless device 202 and a remote location including, for example, an AP. The transmitter 210 and receiver 212 may be combined into a transceiver 214. An antenna 216 may be attached to the housing 208 and electrically coupled to the transceiver 214. Alternatively, or additionally, the wireless device 202 may include an antenna 216 formed as part of the housing 208 or may be an internal antenna. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a data unit for transmission. In some aspects, the data unit may comprise a physical layer data unit (PPDU). In some aspects, the PPDU is referred to as a packet or a frame.

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be housed within a housing 208. Further, the various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together, or may accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

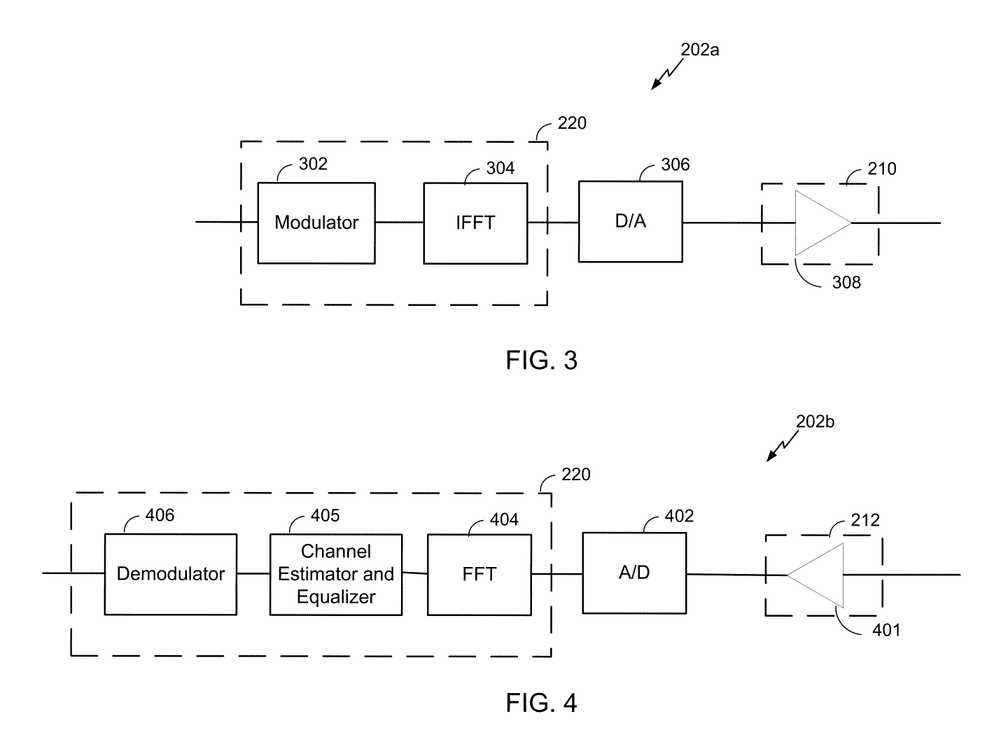

As discussed above, the wireless device 202 may comprise an AP 104 or a STA 106, and may be used to transmit and/or receive communications. FIG. 3 illustrates various components that may be utilized in the wireless device 202 to transmit wireless communications. The components illustrated in FIG. 3 may be used, for example, to transmit OFDM communications. In some aspects, the components illustrated in FIG. 3 are used to transmit data units with training fields with peak-to-power average ratio is as low as possible, as will be discussed in additional detail below. For ease of reference, the wireless device 202 configured with the components illustrated in FIG. 3 is hereinafter referred to as a wireless device 202a.

The wireless device 202a may comprise a modulator 302 configured to modulate bits for transmission. For example, the modulator 302 may determine a plurality of symbols from bits received from the processor 204 or the user interface 222, for example by mapping bits to a plurality of symbols according to a constellation. The bits may correspond to user data or to control information. In some aspects, the bits are received in codewords. In one aspect, the modulator 302 comprises a QAM (quadrature amplitude modulation) modulator, for example a 16-QAM modulator or a 64-QAM modulator. In other aspects, the modulator 302 comprises a binary phase-shift keying (BPSK) modulator or a quadrature phase-shift keying (QPSK) modulator.

The wireless device 202a may further comprise a transform module 304 configured to convert symbols or otherwise modulated bits from the modulator 302 into a time domain. In FIG. 3, the transform module 304 is illustrated as being implemented by an inverse fast Fourier transform (IFFT) module. In some implementations, there may be multiple transform modules (not shown) that transform units of data of different sizes.

In FIG. 3, the modulator 302 and the transform module 304 are illustrated as being implemented in the DSP 220. In some aspects, however, one or both of the modulator 302 and the transform module 304 are implemented in the processor 204 or in another element of the wireless device 202.

As discussed above, the DSP 220 may be configured to generate a data unit for transmission. In some aspects, the modulator 302 and the transform module 304 may be configured to generate a data unit comprising a plurality of fields including control information and a plurality of data symbols. The fields including the control information may comprise one or more training fields, for example, and one or more signal (SIG) fields. Each of the training fields may include a known sequence of bits or symbols. Each of the SIG fields may include information about the data unit, for example a description of a length or data rate of the data unit.

Returning to the description of FIG. 3, the wireless device 202a may further comprise a digital to analog converter 306 configured to convert the output of the transform module into an analog signal. For example, the time-domain output of the transform module 306 may be converted to a baseband OFDM signal by the digital to analog converter 306. The digital to analog converter 306 may be implemented in the processor 204 or in another element of the wireless device 202. In some aspects, the digital to analog converter 306 is implemented in the transceiver 214 or in a data transmission processor.

The analog signal may be wirelessly transmitted by the transmitter 210. The analog signal may be further processed before being transmitted by the transmitter 210, for example by being filtered or by being upconverted to an intermediate or carrier frequency. In the embodiment illustrated in FIG. 3, the transmitter 210 includes a transmit amplifier 308. Prior to being transmitted, the analog signal may be amplified by the transmit amplifier 308. In some aspects, the amplifier 308 comprises a low noise amplifier (LNA).

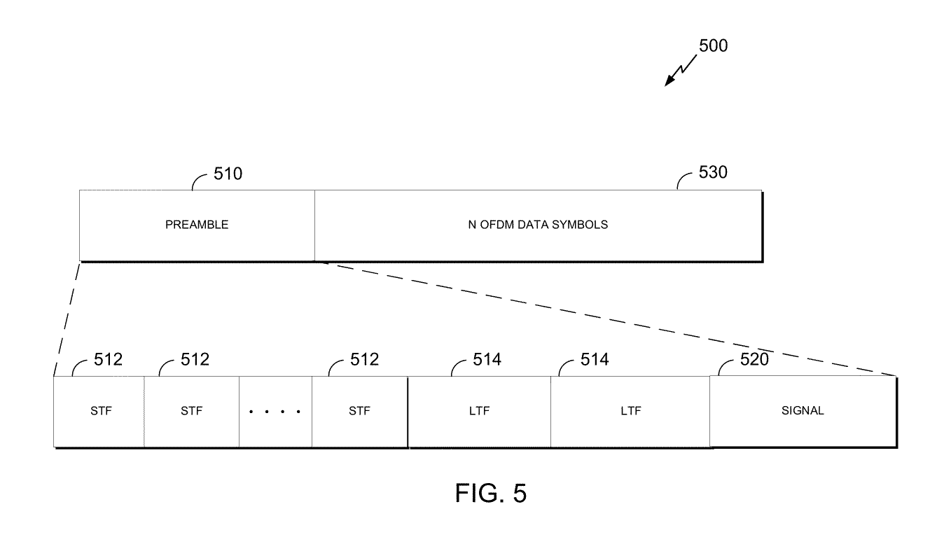

The transmitter 210 is configured to transmit one or more packets, frames, or data units in a wireless signal based on the analog signal. The data units may be generated using the processor 204 and/or the DSP 220, for example using the modulator 302 and the transform module 304 as discussed above. Data units that may be generated and transmitted as discussed above are described in additional detail below with respect to FIGS. 5-8.

FIG. 4 illustrates various components that may be utilized in the wireless device 202 to receive wireless communications. The components illustrated in FIG. 4 may be used, for example, to receive OFDM communications. In some embodiments, the components illustrated in FIG. 4 are used to receive packets, frames, or data units that include one or more training fields, as will be discussed in additional detail below. For example, the components illustrated in FIG. 4 may be used to receive data units transmitted by the components discussed above with respect to FIG. 3. For ease of reference, the wireless device 202 configured with the components illustrated in FIG. 4 is hereinafter referred to as a wireless device 202b.

The receiver 212 is configured to receive one or more packets, frames, or data units in a wireless signal. Data units that may be received, decoded, or otherwise processed as discussed below are described in additional detail with respect to FIGS. 5-8.

In the embodiment illustrated in FIG. 4, the receiver 212 includes a receive amplifier 401. The receive amplifier 401 may be configured to amplify the wireless signal received by the receiver 212. In some aspects, the receiver 212 is configured to adjust the gain of the receive amplifier 401 using an automatic gain control (AGC) procedure. In some aspects, the automatic gain control uses information in one or more received training fields, such as a received short training field (STF) for example, to adjust the gain. Those having ordinary skill in the art will understand methods for performing AGC. In some aspects, the amplifier 401 comprises an LNA.

The wireless device 202b may comprise an analog to digital converter 402 configured to convert the amplified wireless signal from the receiver 212 into a digital representation thereof. Further to being amplified, the wireless signal may be processed before being converted by the digital to analog converter 402, for example by being filtered or by being downconverted to an intermediate or baseband frequency. The analog to digital converter 402 may be implemented in the processor 204 or in another element of the wireless device 202. In some aspects, the analog to digital converter 402 is implemented in the transceiver 214 or in a data receive processor.

The wireless device 202b may further comprise a transform module 404 configured to convert the representation the wireless signal into a frequency spectrum. In FIG. 4, the transform module 404 is illustrated as being implemented by a fast Fourier transform (FFT) module. In some aspects, the transform module may identify a symbol for each point that it uses.

The wireless device 202b may further comprise a channel estimator and equalizer 405 configured to form an estimate of the channel over which the data unit is received, and to remove certain effects of the channel based on the channel estimate. For example, the channel estimator may be configured to approximate a function of the channel, and the channel equalizer may be configured to apply an inverse of that function to the data in the frequency spectrum.

In some aspects, the channel estimator and equalizer 405 uses information in one or more received training fields, such as a long training field (LTF) for example, to estimate the channel. The channel estimate may be formed based on one or more LTFs received at the beginning of the data unit. This channel estimate may thereafter be used to equalize data symbols that follow the one or more LTFs. After a certain period of time or after a certain number of data symbols, one or more additional LTFs may be received in the data unit. The channel estimate may be updated or a new estimate formed using the additional LTFs. This new or update channel estimate may be used to equalize data symbols that follow the additional LTFs. In some aspects, the new or updated channel estimate is used to re-equalize data symbols preceding the additional LTFs. Those having ordinary skill in the art will understand methods for forming a channel estimate.

The wireless device 202b may further comprise a demodulator 406 configured to demodulate the equalized data. For example, the demodulator 406 may determine a plurality of bits from symbols output by the transform module 404 and the channel estimator and equalizer 405, for example by reversing a mapping of bits to a symbol in a constellation. The bits may be processed or evaluated by the processor 204, or used to display or otherwise output information to the user interface 222. In this way, data and/or information may be decoded. In some aspects, the bits correspond to codewords. In one aspect, the demodulator 406 comprises a QAM (quadrature amplitude modulation) demodulator, for example a 16-QAM demodulator or a 64-QAM demodulator. In other aspects, the demodulator 406 comprises a binary phase-shift keying (BPSK) demodulator or a quadrature phase-shift keying (QPSK) demodulator.

In FIG. 4, the transform module 404, the channel estimator and equalizer 405, and the demodulator 406 are illustrated as being implemented in the DSP 220. In some aspects, however, one or more of the transform module 404, the channel estimator and equalizer 405, and the demodulator 406 are implemented in the processor 204 or in another element of the wireless device 202.

As discussed above, the wireless signal received at the receiver 212 comprises one or more data units. Using the functions or components described above, the data units or data symbols therein may be decoded evaluated or otherwise evaluated or processed. For example, the processor 204 and/or the DSP 220 may be used to decode data symbols in the data units using the transform module 404, the channel estimator and equalizer 405, and the demodulator 406.

Data units exchanged by the AP 104 and the STA 106 may include control information or data, as discussed above. At the physical (PHY) layer, these data units may be referred to as physical layer protocol data units (PPDUs). In some aspects, a PPDU may be referred to as a packet, frame, or physical layer packet. Each PPDU may comprise a preamble and a payload. The preamble may include training fields and a SIG field. The payload may comprise a Media Access Control (MAC) header or data for other layers, and/or user data, for example. The payload may be transmitted using one or more data symbols. The systems, methods, and devices herein may utilize data units with training fields whose peak-to-power ratio has been minimized.

FIG. 5 illustrates an example of a frame 500. The frame 500 may comprise a PPDU for use with the wireless device 202. The frame 500 may be used by legacy devices or devices implementing a legacy standard or downclocked version thereof.

The frame 500 includes a preamble 510. The preamble 510 may comprise a variable number of repeating STF 512 symbols, one or more LTF 514 symbols, and a SIGNAL or SIG field 520 In one implementation 10 repeated STF 512 symbols may be set followed by two LTF 512 symbols. The STF 512 may be used by the receiver 212 to perform automatic gain control to adjust the gain of the receive amplifier 401, as discussed above. Furthermore, the STF 512 sequence may be used by the receiver 212 for packet detection, rough timing, and other settings. The LTF 514 may be used by the channel estimator and equalizer 405 to form an estimate of the channel over which the frame 500 is received.

Following the training fields of the preamble 510 in the frame 500 is the SIG field 520. The SIG field 520 may be one OFDM signal that includes various information relating to the transmission rate, the length of the frame 500, and the like. The frame 500 may additionally include a variable number of data symbols 530, such as OFDM data symbols. In a number of embodiments, the frame 500 includes the preamble 510 without including data symbols 530. Advantageously, as will be described further below, in certain embodiments, by not including data symbols 530, the frame 500 can be used to determine a modulation and coding scheme (MCS) more efficiently compared to using a frame with data symbols 530.

When the frame 500 is received at the wireless device 202b, the size of the frame 500 including the training symbols 514 may be computed based on the SIG field 520, and the STF 512 may be used by the receiver 212 to adjust the gain of the receive amplifier 401. Further, a LTF 514 may be used by the channel estimator and equalizer 405 to form an estimate of the channel over which the frame 500 is received. The channel estimate may be used by the processor 220 to decode the plurality of data symbols 530 that follow the preamble 510.

The frame 500 illustrated in FIG. 5 is only an example of a frame or packet that may be used in the system 100 and/or with the wireless device 202. Those having ordinary skill in the art will appreciate that a greater or fewer number of the STFs 412 or LTFs 514 and/or the data symbols 530 may be included in the frame 500. In addition, one or more symbols or fields may be included in the frame 500 that are not illustrated in FIG. 5, and one or more of the illustrated fields or symbols may be omitted.

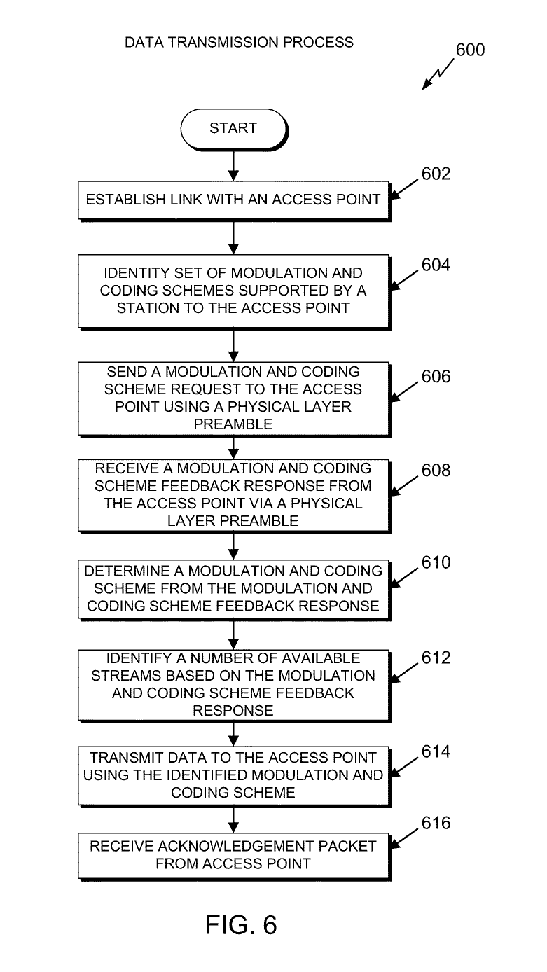

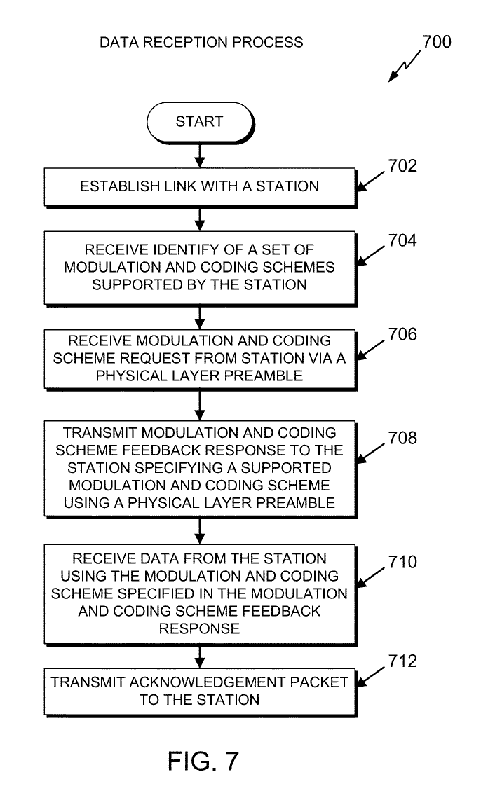

Moreover, the SIG field 520 may include a varying number and type of different fields. According to several embodiments, the SIG field 520 may include fields that facilitate identifying information associated with the frame, such as a length field that can specify the length of a frame 500, or the length of the data symbols 530. Further, the SIG field 520 can include fields that facilitate transmission of packets between a STA 106 and an AP 104. For example, as will be described in more detail with respect to FIGS. 6 and 7, the SIG field 520 can be used to identify an optimal modulation and coding scheme (MCS) for communication between the STA 106 and the AP 104. Table 1 depicts one example embodiment of the one or more fields that may be included in a SIG field 520.

TABLE 1

| Fields of SIG | Bits |
|---|---|
| MCS | 4 |
| Num of Streams | 2 |
| Beacon/NDP | 1 |
| Length | 12 |
| Relative position | 3 |
| SSID Hash | 8 |
| Offset | 10 |
| Reserved | 2 |
| CRC + Tail | 10 |
| Total | 52 |

At least some of the fields listed in Table 1 can be used to facilitate the STA 106 determining an MCS for communicating with the AP 104 that will provide the best data rate with respect to the capabilities of the STA 106 and the AP 104 as well as the condition of the transmission medium during a given time period. Those having skill in the art will understand that the MCS correlates to a data rate for communication between the STA 106 and the AP 104.

FIG. 6 presents a flowchart for one embodiment of a data transmission process 600. The process 600 can be implemented by any wireless node that can transmit and receive frames. For example, a STA 106 can implement the process 600. Advantageously, in certain embodiments, the process 600 enables the STA 106 to determine an MCS that is currently optimal for transmitting data without performing a convergence process. By determining the currently optimal MCS without using a convergence process, in some embodiments, the amount of time required to transmit a packet is decreased. Further, in some cases, the amount of power expended to transmit the packet is also reduced.

The process 600 begins at block 602 when the STA 106 establishes a link with the AP 104. At block 604, the STA 106 identifies to the AP 104 a set of MCSes supported by the STA 106. The STA 106 may identify each MCS individually that the STA 106 can support, or the STA 106 may identify the MCS associated with the fastest data rate that the STA 106 supports. In some embodiments, identifying the MCS associated with the fastest data rate that the STA 106 supports implies that the STA 106 can support any MCS associated with a slower data rate. The STA 106, in some implementations, may identify the MCSes it supports during the process associated with block 602. In certain embodiments, the block 604 is optional.

At block 606, the STA 106 sends a modulation and coding scheme request to the AP 104 using a physical layer preamble 510. The modulation and coding scheme request is generally associated with a request by the STA 106 to the AP 104 to determine the MCS associated with the fastest data rate that the STA 106 can use to ensure correct decoding of data sent by the STA 106 to the AP 104 or recipient of the data.

In certain embodiments, the physical layer preamble 510 is sent without including any data symbols 530. Advantageously, in certain embodiments, sending the physical layer preamble 510 without including data symbols 530 reduces the overhead and expenditure of network resources. For example, the frame comprising the physical layer preamble 510 may be transmitted faster and with the use of less power compared to a frame that includes data symbols. However, in some embodiments, the physical layer preamble 510 may include data symbols 530. For example, the STA 106 may include a first set of data while transmitting the modulation and coding scheme request to the AP 104. Generally, the STA 106 uses the modulation and coding scheme associated with the lowest data rate that the STA 106 supports to send the modulation and coding scheme request. However, in some cases a different modulation and coding scheme may be used.

In a number of embodiments, sending a modulation and coding scheme request to the AP 104 can include the STA 106 configuring the SIG field 520 of the physical layer preamble 510 to create the modulation and coding scheme request. Configuring the SIG field 520 can include setting the values of one or more fields that may be included as part of the SIG field 520, such as those fields listed in Table 1. Table 2 below illustrates one possible configuration for the example fields of the SIG field 520 listed in Table 1 for a modulation and coding scheme request.

TABLE 2

| Fields of SIG | Bits | Comments |
|---|---|---|
| MCS | 4 | Set to 1111 |
| Num SS | 2 | Reserved |
| Beacon/NDP | 1 | Set to 0 |
| Length | 12 | Set to all zeros |
| Relative position | 3 | reserved |
| SSID Hash | 8 | Hash of SSID/BSSID |
| Offset | 10 | reserved |
| Reserved | 2 | |
| CRC + Tail | 10 | 6 bits tail, 4 bits CRC |
| Total | 52 | |

In a number of implementations, the number of possible modulation and coding schemes is less than the number of possible values that can be specified by the number of bits allocated to the MCS field of the SIG field 520. For example, as indicated in Table 1 and Table 2, the number of bits allocated to the MCS field is four allowing for a possibility of sixteen values. If for example, the nodes or devices of the wireless communication system 100 are all configured to support ten or less possible modulation and coding schemes, it is possible to associate the additional possible values for the bit field, which would be six values in this example, for other purposes. Generally, any value for the MCS field that is not associated with a valid MCS can be used for other purposes. Thus, for example, referring to Table 2, the decimal value 15, or binary value 1111, for the MCS field can be used to indicate that the physical layer preamble 510 is being used as a modulation and coding scheme request frame. It is possible to use additional fields of the SIG field 520 to identify the purpose of the physical layer preamble 510. For example, the STA 106 can use a combination of the MCS field and the Beacon/NDP field to indicate a modulation and coding scheme request. For instance, by setting the MCS field to 1111 and the Beacon/NDP field to 0, the STA 106 can specify that the frame it is sending at block 606 is a modulation and coding scheme request.

In some embodiments, other fields of the SIG field 520 may be set to facilitate sending the modulation and coding scheme request. For example, the STA 106 can set the SSID hash field to a value or the hash of a value associated with the AP 104 including the SSID, BSID, or MAC address of the AP 104. Further, other fields of the SIG field 520 may be set differently compared to when data symbols are included with the frame 500. For example, the length field may be set to zero in both the modulation and coding scheme request as well as in a modulation and coding scheme response because, for example, no data symbols are included with the frame 500.

At block 608, the STA 106 receives a modulation and coding scheme feedback response from the AP 104 via a frame that includes a physical layer preamble without including data symbols. At block 610, the STA 106 determines a modulation and coding scheme (MCS) based on the modulation and coding scheme feedback response. Generally, the MCS is determined based on the values of the fields included with the SIG field 520 of the modulation and coding scheme feedback response. Table 2 below illustrates one possible configuration for the example fields of the SIG field 520 listed in Table 1 for a modulation and coding scheme feedback response.

TABLE 3

| Fields of SIG | Bits | Comments |
|---|---|---|
| MCS | 4 | Set to MCS Feedback |
| Num SS | 2 | Number of Streams |
| Beacon/NDP | 1 | Set to 0 |
| Length | 12 | Set to all zeros |
| Relative position | 3 | reserved |
| SSID Hash | 8 | Hash of SSID/BSSID |
| Offset | 10 | reserved |
| Reserved | 2 | |
| CRC + Tail | 10 | 6 bits tail, 4 bits CRC |
| Total | 52 | |

In a number of implementations, as can be seen from Table 3, the MCS field of the SIG field 520 can be set to the MCS that the STA 106 can use to send frames to the AP 104. Generally, the AP 104 specifies the MCS value of the MCS field based on a number of factors including the MCSes that the STA 106 supports, the MCSes that that AP 104 supports, and the present condition or anticipated condition of the communication medium associated with the BSA 102. In some embodiments, other factors may be used to determine the MCS, such as historical load of the AP 104.

In a number of implementations, the MCS identified in the MCS field of the SIG field 520 may be associated with the fastest data rate that the STA 106 can use to transmit data to ensure correct decoding by the AP 104 and/or the recipient of the data. In certain embodiments, the MCS identified may be associated with the fastest data rate that the STA 106 can use during a certain time period. For example, if a large number of STAs are currently transmitting a large number of data packets across the medium, to ensure correct decoding of transmitted data, the STA 106 may need to use an MCS associated with a lower data rate compared to a time period when a smaller number of STAs are transmitting a smaller number of data packets.

At block 612, the STA 106 can identify a number of available streams based on the modulation and coding scheme feedback response. The number of streams can be determined from a Num SS field, as indicated in Table 3, set by the AP 104. Generally, the number of streams refers to the streams that the AP 104 has identified as available for the STA 106. The identified number of streams may be less than or equal to the total number of streams that the AP 104 may be capable of supporting. For instance, an AP 104 that can support 4 streams of traffic may specify during high periods of data traffic that one stream is available for the STA 106. In some embodiments, block 612 may be optional.

At block 614, the STA 106 can transmit data to the AP 104, or to a data recipient, using the modulation and coding scheme identified at block 610. In some embodiments, the STA 106 may also use the number of streams identified at block 612 to facilitate transmitting data to the AP 104, or to a data recipient. At block 616, the STA 106 receives an acknowledgement packet from the AP 104 or the recipient of the data.

FIG. 7 presents a flowchart for one embodiment of a data reception process 700. The process 700 can be implemented by any wireless node that can transmit and receive frames. For example, an AP 104 can implement the process 700. Advantageously, in certain embodiments, the process 700 enables an AP 104 to specify to a STA 106 an MCS that is currently optimal for transmitting data without performing a convergence process. By determining the currently optimal MCS without using a convergence process, in some embodiments, the amount of time required to transmit a packet is decreased. Further, in some cases, the amount of power expended to transmit the packet is also reduced.

The process 700 begins at block 702 when the AP 104 establishes a link with the STA 106. At block 704, the AP 104 receives from the STA 106 the identity of a set of MCSes supported by the STA 106. The AP 104 may receive the identity of each individual MCS supported by the STA 106. Alternatively, the AP 104 may receive the identity of the MCS associated with the fastest data rate that the STA 106 supports. In some embodiments, identifying the MCS associated with the fastest data rate that the STA 106 supports implies that the STA 106 can support any MCS associated with a slower data rate. The AP 104, in some implementations, may receive the identity of the MCSes the STA 106 supports during the process associated with block 702. In certain embodiments, the block 704 is optional.

At block 706, the AP 104 receives a modulation and coding scheme request from the STA 106 via a physical layer preamble 510. Generally, the physical layer preamble 510 received at block 706 corresponds to the physical layer preamble sent at block 606 above. Thus, for example, the physical layer preamble 510 of block 706 may include a SIG field 520 with the set of fields and values listed above in Table 2. Further, in some implementations, some or all of the embodiments described above with respect to block 606 may apply to block 706.

At block 708, the AP 104 transmits a modulation and coding scheme feedback response to the STA 106 specifying a supported modulation and coding scheme. The modulation and coding scheme feedback response can be transmitted using a physical layer preamble 510. Further, as described above with respect to block 608, the modulation and coding scheme feedback response may include a SIG field 520 with the set of fields and values described above in Table 3. Further, in some implementations, some or all of the embodiments described above with respect to block 608 may apply to block 708.

At block 710, the AP 104 receives data from the STA 106 using the modulation and coding scheme specified in the modulation and coding scheme feedback response. In some embodiments, the AP 104 may receive data from the STA 106 using a modulation and coding scheme associated with a slower data rate than the modulation and coding scheme that the AP 104 specified as part of the modulation and coding scheme feedback response. In certain cases, the STA 106 may transmit data to another STA using the modulation and coding scheme specified by the AP 104 as part of the modulation and coding scheme feedback response.

At block 712, the AP 104 transmits an acknowledgement packet or frame to the STA 106. Generally, the AP 104 may use the same MCS to transmit the acknowledgement packet as the AP 104 identified in the modulation and coding scheme feedback response. In some embodiments, the AP 104 uses the same MCS to transmit the acknowledgment packet at the STA 106 used to transmit the data.

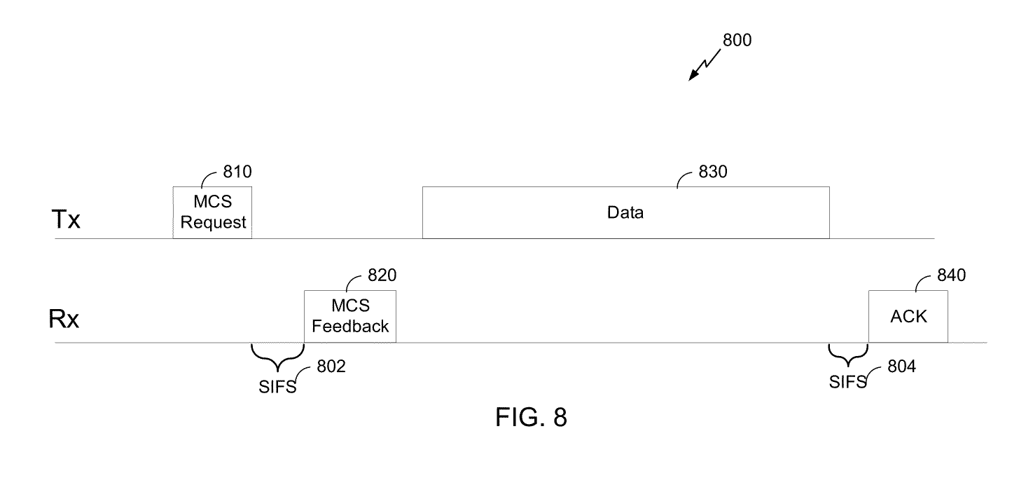

FIG. 8 illustrates an example of a packet flow 800 in accordance with an embodiment of the present disclosure. The packet flow 800 is associated with a STA 106. The flow begins at block 810 with the STA 106 sending an MCS request to an AP 104. As described above, the MCS request is associated with a request for the AP 104 to specify the MCS associated with the fastest data rate that the STA 106 can use to transmit data to ensure correct decoding by the recipient of the data. Generally, the AP 104 is an AP with which the STA 106 has established a link. However, in some embodiments, the STA 106 may broadcast the MCS request without specifying a specific recipient to receive the MCS request.

At block 820, the STA 106 receives an MCS feedback response from the AP 104. In certain embodiments, the STA 106 may receive the MCS feedback response from an AP with which the STA 106 has established a link. However, in some embodiments, the STA 106 may receive the MCS feedback response from an AP with which the STA 106 has not established a link. In certain embodiments, the STA 106 may establish a link with the AP that provided the MCS feedback response. In a number of embodiments, the MCS feedback response is received within a Short Interframe Space (SIFS) 802. In certain embodiments, the MCS feedback response is broadcast without identifying a specific STA. In such embodiments, the STA 106 can identify that the MCS feedback response is intended for the STA 106 based on whether the MCS feedback response was received within a SIFS 802. In some embodiments, if the MCS feedback response is not received within a SIFS 802, the STA 106 can determines that the AP 104 failed to receive the MCS request.

After receiving the MCS feedback response, the STA 106 uses the MCS identified in the MCS feedback response to transmit data 830 to an AP 104 or other recipient. If the transmission of the data is successful, the STA 106, in some embodiments, will receive an acknowledgement packet at block 840. Generally, if the transmission of data is successful, the STA 106 receives the acknowledgement packet within a SIFS 804.

As has previously been described, certain embodiments of the present disclosure provide for reduced transmission time and reduced power usage compared to systems using legacy MCS request processes or that default to the MCS associated with the slowest data rate. As indicated in Table 4 below, simulations of a sensor sending a 256 byte packet with a 2.5 MHz bandwidth indicate transmission time, and consequently power savings, of approximately 55% compared to using the MCS associated with the lowest data rate, and savings of approximately 30% compared to using legacy MCS request methods.

TABLE 4
Total time at lowest MCS (ACK is included in all cases) (μs) 3208

| | 64 QAM | 64 QAM | 64 QAM |
|---|---|---|---|
| | ⅔ | ¾ | ⅚ |
| Total time at highest MCS with | 2072 | 2040 | 2008 |
| legacy MCS request response (μs) | | | |
| Total time at highest MCS with low | 1456 | 1424 | 1392 |
| overhead MCS request response (μs) | | | |

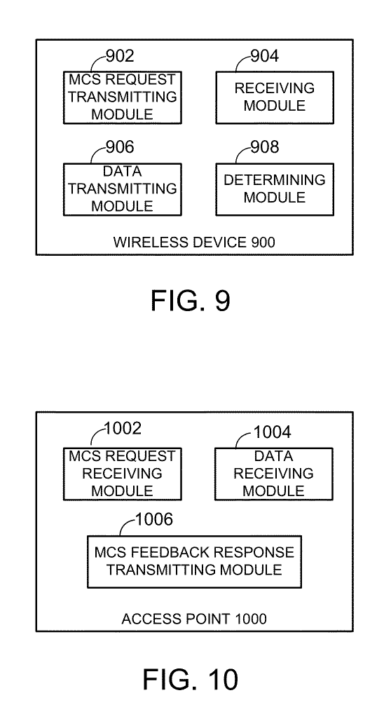

FIG. 9 illustrates another example of a wireless device 900 that may be employed within the wireless communication system of FIG. 1. The wireless device 900 comprises a MCS request transmitting module 902, a receiving module 904, a data transmitting module 906, and a determining module 908. The MCS request transmitting module 902 is capable of transmitting an MCS request to an AP 104. Further, the MCS request transmitting module 902 may be configured to perform one or more of the functions discussed above with respect to the block 606 illustrated in FIG. 6. The MCS request transmitting module 902 may correspond to one or more of the transmitter 210 and the transceiver 214. Further, the MCS request transmitting module 902 may include one or more of the processor 204, the DSP 220, the memory 206, and any other component that may facilitate performing one or more of the functions discussed above with respect to the block 606.

The receiving module 904 is capable of receiving a modulation and coding scheme feedback response from an AP 104. Further, the receiving module 904 may be configured to perform one or more of the functions discussed above with respect to the block 608. The receiving module 904 may correspond to one or more of the receiver 212 and the transceiver 214. Further, the receiving module 904 may include one or more of the processor 204, the DSP 220, the memory 206, the signal detector 218, and any other component that may facilitate performing one or more of the functions discussed above with respect to the block 608.

The data transmitting module 906 is capable of transmitting data to an AP 104 or another wireless device or STA. Further, the receiving module 904 may be configured to perform one or more of the functions discussed above with respect to the block 614. The data transmitting module 906 may correspond to one or more of the transmitter 210 and the transceiver 214. Further, the data transmitting module 906 may include one or more of the processor 204, the DSP 220, the memory 206, and any other component that may facilitate performing one or more of the functions discussed above with respect to the block 614.

The determining module 908 is capable of determining an MCS based on a modulation and coding scheme feedback response received from an AP 104. Further, the determining module 908 may be configured to perform one or more of the functions discussed above with respect to the block 610 and/or the block 612. The determining module 908 may correspond to one or more of the processor 204 and the DSP 220. Further, the determining module 908 may include one or more of the memory 206, the signal detector 218, and any other component that may facilitate performing one or more of the functions discussed above with respect to the block 610 and/or the block 612.

FIG. 10 illustrates an example of an access point 1000 that may be employed within the wireless communication system of FIG. 1. The access point 1000 comprises a MCS request receiving module 1002, a data receiving module 1004, and a MCS feedback response transmitting module 1006. The MCS request receiving module 1002 is capable of receiving an MCS request from a STA 106. Further, the MCS request receiving module 1002 may be configured to perform one or more of the functions discussed above with respect to the block 706 illustrated in FIG. 7. The MCS request receiving module 1002 may correspond to one or more of a receiver and a transceiver. Further, the MCS request receiving module 1002 may include one or more of a processor, a DSP, memory, and any other component that may facilitate performing one or more of the functions discussed above with respect to the block 706.

The data receiving module 1004 is capable of receiving data from a STA 106. Further, the data receiving module 1004 may be configured to perform one or more of the functions discussed above with respect to the block 710. The data receiving module 1006 may correspond to one or more of a receiver and a transceiver. Further, the data receiving module 1004 may include one or more of a processor, a DSP, memory, a signal detector, and any other component that may facilitate performing one or more of the functions discussed above with respect to the block 710.

The MCS feedback response transmitting module 1006 is capable of transmitting an MCS feedback response to a STA 106. Further, the MCS feedback response transmitting module 1006 may be configured to perform one or more of the functions discussed above with respect to the block 708 illustrated in FIG. 7. The MCS feedback response transmitting module 1006 may correspond to one or more of a transmitter and a transceiver. Further, the MCS feedback response transmitting module 1006 may include one or more of a processor, a DSP, a memory, and any other component that may facilitate performing one or more of the functions discussed above with respect to the block 708.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communication, comprising
sending a modulation and coding scheme request to an access point, wherein the modulation and coding scheme request is sent using a first physical layer preamble frame and includes an identifier associated with the access point;
in response to sending the modulation and coding scheme request, receiving at a station a modulation and coding scheme feedback response from the access point, wherein the modulation and coding scheme feedback response is received as a second physical layer preamble frame;
determining a modulation and coding scheme based on the modulation and coding scheme feedback response; and
transmitting data to the access point using the identified modulation and coding scheme.

2. The method of claim 1, further comprising identifying the modulation and coding scheme based on a modulation and coding scheme field associated with the second physical layer preamble frame.

3. The method of claim 2, further comprising identifying the modulation and coding scheme based on the modulation and coding scheme field including a bit pattern not associated with a valid modulation and coding scheme.

4. The method of claim 1, wherein the modulation and coding scheme feedback response specifies the modulation and coding scheme associated with the fastest data rate that the station can use to ensure correct decoding of data transmitted to the access point.

5. The method of claim 1, wherein the modulation and coding scheme feedback response specifies the modulation and coding scheme associated with the fastest data rate that the station can use to ensure correct decoding of data transmitted to the access point at a specific time.

6. The method of claim 1, further comprising identifying to the access point a set of modulation and coding schemes supported by the station.

7. The method of claim 6, wherein the modulation and coding scheme is associated with the set of modulation and coding schemes.

8. The method of claim 6, wherein the modulation and coding scheme feedback response specifies the modulation and coding scheme associated with the fastest data rate from the set of modulation and coding schemes that the station can use to ensure correct decoding of data transmitted to the access point.

9. The method of claim 1, wherein the modulation and coding scheme feedback response specifies a number of available streams.

10. The method of claim 1, wherein the modulation and coding scheme feedback response is transmitted a short interframe space after the modulation and coding scheme feedback request is transmitted.

11. The method of claim 1, further comprising receiving an acknowledgement packet in response to transmitting the data.

12. The method of claim 1, wherein a length field associated with the modulation and coding scheme request is set to zero.

13. The method of claim 1, wherein a length field associated with the modulation and coding scheme feedback response is set to zero.

14. The method of claim 1, wherein a length field associated with the modulation and coding scheme feedback response is set to a value less than the smallest valid 802.11 frame size associated with at least one of the following: a control frame, a data frame, and a management frame.

15. The method of claim 14, wherein the identifier can comprise at least one of the following: a hash of a SSID, a hash of a BSSID, and a MAC address.

16. A method for wireless communication, comprising
receiving at an access point a modulation and coding scheme request from a station, wherein the modulation and coding scheme request is received as a first physical layer preamble frame and includes an identifier associated with the access point;
in response to receiving the modulation and coding scheme request, sending to the station a modulation and coding scheme feedback response, wherein a modulation and coding scheme field associated with the modulation and coding scheme feedback response specifies a modulation and coding scheme, and wherein the modulation and coding scheme feedback response is sent using a second physical layer preamble frame; and
receiving data from the station using the modulation and coding scheme.

17. The method of claim 16, further comprising determining that the first physical layer preamble frame is the modulation and coding scheme request based at least in part on a modulation and coding scheme field associated with the first physical layer preamble frame.

18. The method of claim 17, further comprising determining that the first physical layer preamble frame is the modulation and coding scheme request based at least in part on the modulation and coding scheme field including a bit pattern not associated with a valid modulation and coding scheme.

19. The method of claim 16, wherein the modulation and coding scheme feedback response specifies the modulation and coding scheme associated with the fastest data rate that the station can use to ensure correct decoding of data transmitted to the access point.

20. The method of claim 16, wherein the modulation and coding scheme feedback response specifies the modulation and coding scheme associated with the fastest data rate that the station can use to ensure correct decoding of data transmitted to the access point at a specific time.

21. The method of claim 16, further comprising receiving from the station a set of modulation and coding schemes supported by the station.

22. The method of claim 21, wherein the modulation and coding scheme is associated with the set of modulation and coding schemes.

23. The method of claim 21, wherein the modulation and coding scheme feedback response specifies the modulation and coding scheme associated with the fastest data rate from the set of modulation and coding schemes that the station can use to ensure correct decoding of data transmitted to the access point.

24. The method of claim 16, wherein the modulation and coding scheme feedback response specifies a number of available streams.

25. The method of claim 16, wherein the modulation and coding scheme feedback response is transmitted a short interframe space after the modulation and coding scheme feedback request is transmitted.

26. The method of claim 16, further comprising sending an acknowledgement packet in response to receiving the data.

27. An apparatus for wireless communication, comprising:
a transmitter configured to transmit a modulation and coding scheme request to an access point, wherein the modulation and coding scheme request is sent using a first physical layer preamble frame and includes an identifier associated with the access point;
a receiver configured to receive a modulation and coding scheme feedback response from the access point in response to transmission of the modulation and coding scheme request, wherein the modulation and coding scheme feedback response is received as a second physical layer preamble frame;
a processor configured to determine a modulation and coding scheme based on the modulation and coding scheme feedback response; and
the transmitter further configured to transmit data to the access point using the identified modulation and coding scheme.

28. The apparatus of claim 27, wherein the processor is further configured to determine the modulation and coding scheme based on a modulation and coding scheme field associated with the second physical layer preamble frame.

29. The apparatus of claim 27, wherein the modulation and coding scheme feedback response specifies the modulation and coding scheme associated with the fastest data rate that the station can use to ensure correct decoding of data transmitted to the access point.

30. The apparatus of claim 27, wherein the modulation and coding scheme feedback response specifies the modulation and coding scheme associated with the fastest data rate that the station can use to ensure correct decoding of data transmitted to the access point at a specific time.

31. The apparatus of claim 27, wherein the transmitter is further configured to identify to the access point a set of modulation and coding schemes supported by the apparatus.

32. The apparatus of claim 31, wherein the modulation and coding scheme is associated with the set of modulation and coding schemes.

33. The apparatus of claim 31, wherein the modulation and coding scheme feedback response specifies the modulation and coding scheme associated with the fastest data rate from the set of modulation and coding schemes that the station can use to ensure correct decoding of data transmitted to the access point.

34. The apparatus of claim 27, wherein the modulation and coding scheme feedback response specifies a number of available streams.

35. The apparatus of claim 27, wherein the modulation and coding scheme feedback response is transmitted a short interframe space after the modulation and coding scheme feedback request is transmitted.

36. The apparatus of claim 27, wherein the receiver is further configured to receive an acknowledgement packet in response to transmission of the data.

37. An access point for wireless communication, comprising
at least one antenna;
a receiver configured to receive via the at least one antenna a modulation and coding scheme request from a station, wherein the modulation and coding scheme request is received as a first physical layer preamble frame and includes an identifier associated with the access point;
a transmitter configured to send via the at least one antenna to the station a modulation and coding scheme feedback response in response to receipt of the modulation and coding scheme request, wherein a modulation and coding scheme field associated with the modulation and coding scheme feedback response specifies a modulation and coding scheme, and wherein the modulation and coding scheme feedback response is sent using a second physical layer preamble frame; and
the receiver further configured to receive data from the station using the modulation and coding scheme.

38. The access point of claim 37, further comprising a processor configured to determine that the first physical layer preamble frame is the modulation and coding scheme request based at least in part on a modulation and coding scheme field associated with the first physical layer preamble frame.

39. The access point of claim 37, wherein the modulation and coding scheme feedback response specifies the modulation and coding scheme associated with the fastest data rate that the station can use to ensure correct decoding of data transmitted to the access point.

40. The access point of claim 37, wherein the modulation and coding scheme feedback response specifies the modulation and coding scheme associated with the fastest data rate that the station can use to ensure correct decoding of data transmitted to the access point at a specific time.

41. The access point of claim 37, wherein the receiver is further configured to receive from the station a set of modulation and coding schemes supported by the station.

42. The access point of claim 41, wherein the modulation and coding scheme is associated with the set of modulation and coding schemes.

43. The access point of claim 41, wherein the modulation and coding scheme feedback response specifies the modulation and coding scheme associated with the fastest data rate from the set of modulation and coding schemes that the station can use to ensure correct decoding of data transmitted to the access point.

44. The access point of claim 37, wherein the modulation and coding scheme feedback response specifies a number of available streams.

45. The access point of claim 37, wherein the modulation and coding scheme feedback response is transmitted a short interframe space after the modulation and coding scheme feedback request is transmitted.

46. The access point of claim 37, wherein the transmitter is further configured to transmit an acknowledgment packet in response to receiving the data.

47. An apparatus for wireless communication, comprising:
means for sending a modulation and coding scheme request to an access point, wherein the modulation and coding scheme request is sent using a first physical layer preamble frame and includes an identifier associated with the access point;
means for receiving a modulation and coding scheme feedback response from the access point, wherein the modulation and coding scheme feedback response is received as a second physical layer preamble frame;
means for determining a modulation and coding scheme based on the modulation and coding scheme feedback response; and
means for transmitting data to the access point using the identified modulation and coding scheme.

48. An access point for wireless communication, comprising:
means for receiving a modulation and coding scheme request from a station, wherein the modulation and coding scheme request is received as a first physical layer preamble frame and includes an identifier associated with an access point;
means for sending to the station a modulation and coding scheme feedback response, wherein a modulation and coding scheme field associated with the modulation and coding scheme feedback response specifies a modulation and coding scheme, and wherein the modulation and coding scheme feedback response is sent using a second physical layer preamble frame; and
means for receiving data from the station using the modulation and coding scheme.

49. A non-transitory physical computer storage comprising computer executable instructions configured to implement a method for wireless communication, the method comprising:
sending a modulation and coding scheme request to an access point, wherein the modulation and coding scheme request is sent using a first physical layer preamble frame and includes an identifier associated with the access point;
in response to sending the modulation and coding scheme request, receiving at a station a modulation and coding scheme feedback response from the access point, wherein the modulation and coding scheme feedback response is received as a second physical layer preamble frame;
determining a modulation and coding scheme based on the modulation and coding scheme feedback response; and
transmitting data to the access point using the identified modulation and coding scheme.

50. A non-transitory physical computer storage comprising computer executable instructions configured to implement a method for wireless communication, the method comprising:
receiving at an access point a modulation and coding scheme request from a station, wherein the modulation and coding scheme request is received as a first physical layer preamble frame and includes an identifier associated with the access point;
in response to receiving the modulation and coding scheme request, sending to the station a modulation and coding scheme feedback response, wherein a modulation and coding scheme field associated with the modulation and coding scheme feedback response specifies a modulation and coding scheme, and wherein the modulation and coding scheme feedback response is sent using a second physical layer preamble frame; and
receiving data from the station using the modulation and coding scheme.
